(19) United States
(12) Patent Application Publication
(10) Pub. No.: US 2022/0401204 A1
(43) Pub. Date: Dec. 22, 2022

(54) INFLATABLE ANIMAL SUPPORT APPARATUS

(71) Applicants: Mikhael Vitenson, Cornelius, NC (US); Jacqueline Fontoura Vitenson, Cornelius, NC (US)

(72) Inventors: Mikhael Vitenson, Cornelius, NC (US); Jacqueline Fontoura Vitenson, Cornelius, NC (US)

(21) Appl. No.: 17/352,782

(22) Filed: Jun. 21, 2021

(51) Int. Cl. A61D 3/00; A01K 13/00

(52) U.S. Cl. CPC A61D 3/00; A01K 13/00

(57) ABSTRACT

An animal support apparatus includes an inflatable base including an interior volume. The interior volume of the inflatable base receives air to inflate the base to a range of air pressures. The inflatable base defines a recess configured to support an animal. At least one attachment strap secures the animal in the recess of the inflatable base or directly onto an upper surface of the inflatable base. Eyelets are coupled to the inflatable base at various locations to secure the animal in the recess of the inflatable base or to the upper surface of the inflatable base. The eyelets may also be employed to secure the inflatable base to a support table. A valve passes air into or out of the interior volume of the inflatable base to inflate the inflatable base to the range of air pressures.

### BACKGROUND

### Technical Field

The present disclosure relates to an animal support apparatus and, more particularly, to an inflatable animal support apparatus.

Background of Related Art

Animal or animal grooming may include nail clipping or grinding, washing and drying the animal's coat, cutting the animal's hair with either scissors or clippers, cleaning the animal's paws and ears and massaging and otherwise treating the animal. However, animal grooming often requires that animal be at least partially immobilized in a comfortable positions that is not stressful to the animal. In addition to immobilizing the animal, some animals have medical problems, joint problems, or are old and are unable to stand. In order to properly groom the animal, standing is important.

Veterinary care of various animals (e.g., dogs and cats) may similarly require that the animal be at least partially immobilized in a comfortable apparatus that does not induce a stress reaction in the animal.

Similarly, animal transport of an animal that is at least partially immobilized may require immobilizing the animal on an apparatus that can be moved about with the animal secured to the apparatus in manner that is comfortable and not stressful to the animal.

### SUMMARY

In accordance with an aspect of the present disclosure, an animal support apparatus includes an inflatable base. The inflatable base includes an interior volume. The interior volume of the inflatable base is configured to receive air to inflate the base to a range of air pressures. The inflatable base defines a recess configured to support an animal on the inflatable base. At least one attachment strap is coupled to the inflatable base. The attachment strap secures the animal in the recess of the inflatable base or directly onto an upper surface of the inflatable base. Eyelets are coupled to the inflatable base at various locations. The eyelets are configured to secure the animal in the recess of the inflatable base or to the upper surface of the inflatable base. The eyelets may also be employed to secure the inflatable base to a support table. A valve is connected with the inflatable base. The valve is in fluid communication with the interior volume of the inflatable base. The valve passes air into or out of the interior volume of the inflatable base to inflate the inflatable base to the range of air pressures.

In some aspects, the inflatable base includes a base member and an animal support member. The animal support member is on the base member.

In some aspects, the base member is a second inflatable base defining a second interior volume. The second interior volume of the second inflatable base receives air to inflate the second inflatable base to a range of air pressures. Air may also be released from the second inflatable base to create a range of air pressures.

In some aspects, a second valve is connected with the second inflatable base. The second valve is in fluid communication with the second interior volume of the second inflatable base. The second valve passes air into or out of the second interior volume of the second inflatable base to inflate the second inflatable base to the range of air pressures.

In some aspects, first and second valves are connected with the interior volume of the inflatable base. The first valve passes air into the interior volume of the inflatable base, and the second valve passes air out of the interior volume of the inflatable base.

In some aspects, a headrest extends from the inflatable base. The headrest may include an interior volume in fluid communication with the interior volume of the inflatable base.

In some aspects, at least two handles are coupled to the inflatable base. The at least two handles can be employed for lifting the inflatable base (e.g., with the animal supported on the inflatable base).

### BRIEF DESCRIPTION OF THE DRAWINGS

The accompanying drawings, which are incorporated in and constitute a part of this specification, illustrate embodiments of the present disclosure and, together with the detailed description below, serve to further explain the present disclosure, in which:

FIG. 1 is a front, perspective view of an animal support apparatus in accordance with the present disclosure;

FIG. 2 is a rear, perspective view of the animal support apparatus of FIG. 1;

FIG. 3 is a front, perspective view of another animal support apparatus in accordance with the present disclosure;

FIG. 4 is a rear, perspective view of the animal support apparatus of FIG. 3;

FIG. 5 is a front, perspective view of another animal support apparatus in accordance with the present disclosure;

FIG. 6 is a rear, perspective view of the animal support apparatus of FIG. 5; and

FIG. 7 is a front, perspective view of the animal support apparatus of FIG. 1 supporting an animal.

### DETAILED DESCRIPTION

Descriptions of technical features or aspects of an exemplary embodiment of the present disclosure should typically be considered as available and applicable to other similar features or aspects in another exemplary embodiment of the present disclosure. Accordingly, technical features described herein according to one exemplary embodiment of the present disclosure may be applicable to other exemplary embodiments of the present disclosure, and thus duplicative descriptions may be omitted herein.

Exemplary embodiments of the present disclosure will be described more fully below (e.g., with reference to the accompanying drawings). Like reference numerals may refer to like elements throughout the specification and drawings.

The phrases “apparatus” and “animal support apparatus” may be used interchangeably herein.

The animal support apparatuses described herein can assist with any part of the animal grooming process, either by professional groomers or at home by animal owners. The animal support apparatuses described herein can also be used for various veterinary procedures that require immobilizing or adding comfort to the animal (e.g., a pet dog or cat) while performing the procedure.

Conventional apparatus may require hanging the animal in a harness or clipping a harness or a rope to a grooming table. These apparatus can hurt or scar the animal. These apparatus are also not comfortable for the animal and may exacerbate existing conditions such as arthritis, joint pain, stomach irritation, etc. In addition, these apparatus cannot be used for an extended period of time.

Conventional apparatus may be made of metal or other hard surface that can be placed under a dog's paws to raise them. These apparatus are clunky, heavy, difficult to store and can bruise or hurt the animal.

In an aspect of the present disclosure, the animal supporting apparatus increases stability while maintaining the animal's comfort and wellbeing. This feature assists in the grooming or treatment process while helping the animal feel safe, comfortable and secure. The connection between the animal's body and the surface of the apparatus helps the animal feel cuddled and reduces the stress of treatment or grooming. In addition, for animals with joint or other medical problems or senior animals who have difficulties standing for an extended period of time while being groomed, the animal supporting apparatus assists in keeping the animal upright in comfort. The support animal supporting apparatus helps animals to stand (or remain upright) during the grooming process.

In an aspect of the present disclosure, the animal supporting apparatus includes an inflatable base that can be placed on a grooming table, a veterinarian treatment table, or at home on a table or the floor or on any other supportive surface. The apparatus can be placed under the animal and when inflated causes the animal's chest, under the belly nearest to the hind legs, or the entire body to be elevated, resting on the inflatable apparatus.

The animal supporting apparatus can be sized differently depending on the animal's breed, size and weight. The apparatus can be inflated more or less to meet the desired effect.

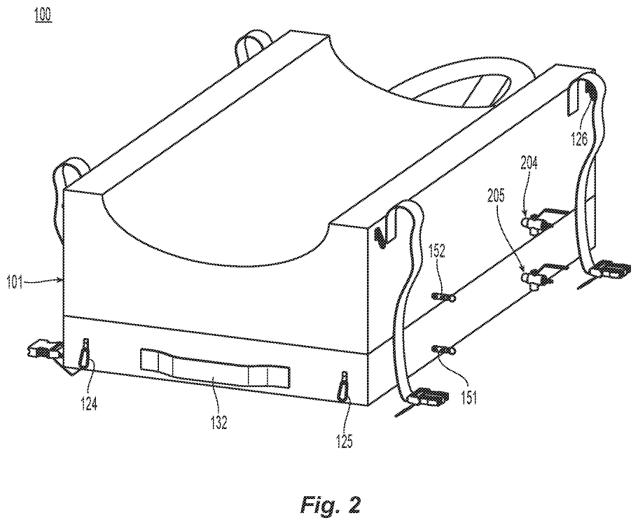

The apparatus may have a pressure relief valve (e.g., one of pressure relief valves 151 or 152 shown in FIG. 2) to ensure that it is not overinflated. The pressure relief valve is configured to release air from an inflatable base when a maximum pressure is reached. Thus, the pressure relief valve can be used to define a maximum pressure to which the inflatable base can be inflated. The base member and the animal support member described herein may each include a pressure relief valve. The apparatus also has one or more valves to assist in properly inflating or defaulting the apparatus or to assist in fine tuning the inflation levels.

In use, the animal supporting apparatus can raise the front paws, back paws or all paws off the ground, making movement for the animal (e.g., dog) difficult while the animal is being groomed or treated.

In one embodiment, the apparatus can be used to raise either the front or back paws. In another embodiment, the apparatus can be used to raise the front paws. In another embodiment, the apparatus can be used to raise the rear paws. In yet another embodiment, the apparatus can be used to raise all 4 paws. In yet another embodiment, the apparatus can be used to raise the front or all 4 paws and raise the head such that the head rests on the inflatable apparatus.

The apparatus can have straps that may go around the animal from the top, around the head, around the paws, around the heaps or crisscrossing the animal's body or in any other one or more combinations securing the animal to the apparatus. The straps can be Velcro®, clipped or tied around the animal in any combination. The straps may be stationary or can be clipped via a carabineer or other clipping apparatus to grommets or other loops (e.g., eyelets) on the apparatus. The straps may be hard or elastic. The straps may also be secured via a loop. The straps or loop may be further secured up to the grooming arm on a grooming table or a veterinarian table or via any other method to an elevated surface, or down to the grooming table arm or other parts of the grooming table or via any other method to the bottom. The straps may include a locking mechanism configured to secure the straps about an animal.

In addition to the straps, a harness may be either stationary (i.e., part of the apparatus) in which the front or rear paws or all paws may rest, or a harness may be attached to the apparatus via a carabineer or other clipping apparatus or Velcro® to grommets or other loops attached to the apparatus.

The apparatus can have a soft bottom or a hard bottom for greater stability (i.e., a plate on the bottom to stabilize the apparatus). The apparatus can be made of different types of inflatable vinyl or PVC materials to avoid puncture by the animal's nails. As an example, a rubber base may be included on the bottom of the pet supporting apparatus to prevent sliding of the apparatus.

The apparatus can have metal or plastic supports to ensure the size and maintain the desired shape.

The apparatus may have a Velcro® or other connection to the grooming or treatment table or the floor to ensure that the apparatus does not move.

The apparatus can be inflated and deflated manually, utilizing internal or external pump or utilizing groomer's blower to inflate and vacuum to deflate. An integrated pump may be included in the animal support apparatus. The integrated pump may be disposed in the interior volume of the inflatable base described herein. An external pump may also be employed.

The animal support apparatus may include a heating apparatus or internal apparatus that may massage or caress the animal.

The apparatus may have pockets or pouches to store grooming accessories such as combs, scissors, clippers, etc. or veterinary medical devices.

The apparatus may have the ability to attach an arm to hold a blower, light or other apparatus used in the course of grooming or veterinary treatment.

The apparatus may include storage features with compartments for sets of apparatuses (i.e., for small dogs, medium dogs, large dogs, cats or other animals). The apparatus may also include a travel case for easy travel.

In one embodiment, the apparatus may have compartments that may separately inflate for front paws, back paws, all paws and head support. In another embodiment, the apparatus may have different compartments that may separately inflate for different animal sizes.

The apparatus may also have extensions that can be attached to the apparatus to create a portable inflatable animal cage. The apparatus may be inflated such that the bottom becomes an animal pillow. The cage extensions can be attached to the apparatus via grommets or loops in a manner so that to enclose the animal for travel or periodic restraint. All of the other parts of the apparatus can be used as part of the inflatable cage, including the harness or other restraints.

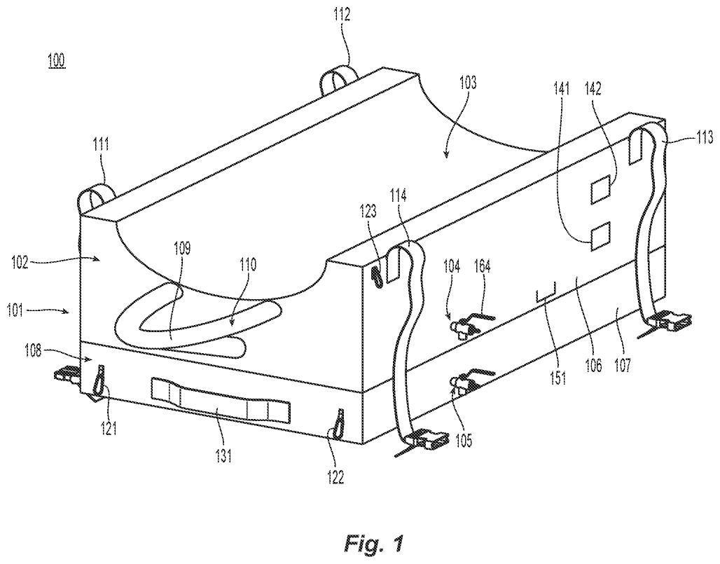

Referring to FIGS. 1 to 2 and 7, in accordance with an aspect of the present disclosure, an animal support apparatus 100 includes an inflatable base 101. The inflatable base 101 includes an interior volume 102. The interior volume 102 of the inflatable base 101 is configured to receive air to inflate the inflatable base 101 to a range of air pressures.

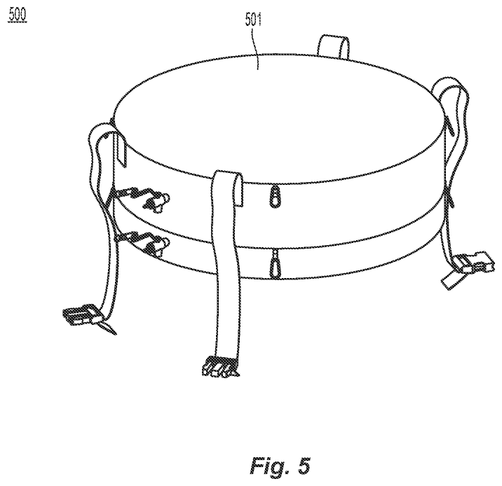

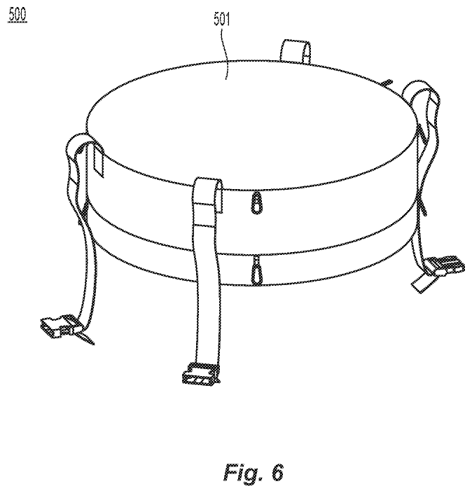

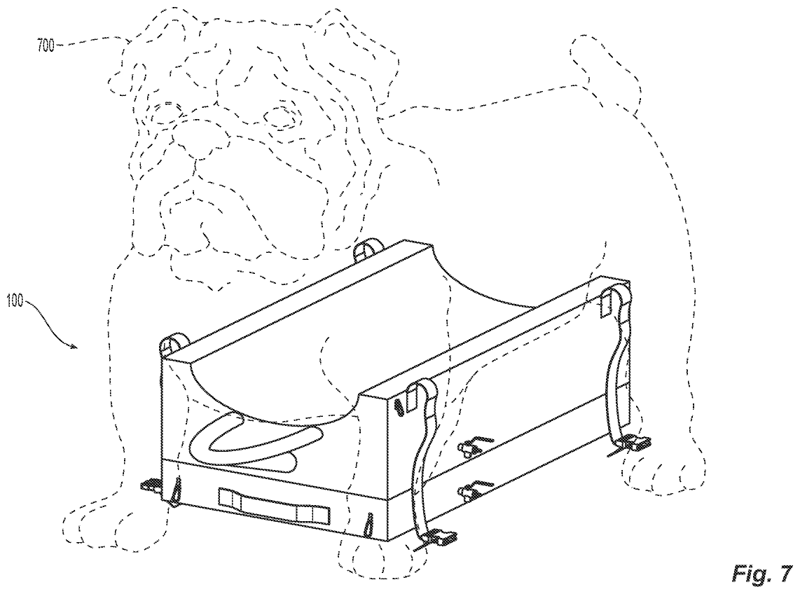

The inflatable base 101 may define a recess 103 configured to support an animal (see, e.g., animal 700 in FIG. 7) on the inflatable base 101. According to some embodiments, the recess 103 may be omitted, and the inflatable base 101 may define a substantially flat or concave upper surface (see, e.g., upper surface 501 in FIGS. 5-6).

At least one attachment strap (e.g., straps 111, 112, 113 and/or 114) is coupled to the inflatable base 101. The attachment strap secures the animal in the recess 103 of the inflatable base 101. The attachment strap may secure the animal directly onto an upper surface (e.g., upper surface 501) of the inflatable base (see, e.g., FIGS. 5-6). As an example, two straps may be employed to secure front and rear portions of an animal to the inflatable base 101.

Eyelets (e.g., eyelets 121, 122, 123, 124 and/or 125) may be coupled to the inflatable base 101 at various locations about the inflatable base 101. The eyelets are configured to secure the animal in the recess 103 of the inflatable base or to the upper surface of the inflatable base. The eyelets may also be employed to secure the inflatable base 101 to a support table or other similar support structure.

A valve (e.g., valve 104 and/or valve 105) may be connected with the inflatable base 101. The valve (e.g., valve 104) is in fluid communication with the interior volume 102 of the inflatable base 101. The valve passes air into or out of the interior volume 102 of the inflatable base 101 to inflate the inflatable base 101 to the range of air pressures. A single bi-directional valve may be employed and used to pass air both into and out of the interior volume 102 of the inflatable base 101. The bi-directional valve may operate as a pressure relief valve configured to define a maximum pressure to which the inflatable base 101 can be inflated. The valve may include a valve shutoff member 164 that prevents any air from passing into or out of the valve. The valve shutoff member 164 can also be employed to fully open the valve to let air drain out into the external atmosphere. The valve is configured for connection with an air pump, as described herein. The air pump may be dynamically activated to pass air into or out of the inflatable base 101 to maintain a desired pressure of the inflatable base 101. The air pump and valve may also be used to inflate the inflatable base 101 underneath an animal to raise the animal from a seated or prone/supine position. The air pump and valve may similarly be used to deflate the base to lower the animal.

In some aspects, the inflatable base 101 includes a base member 107 and an animal support member 106. The animal support member 106 is on the base member 107. That is, the inflatable base 101 may be two separate members stacked on each other.

The base member 107 may be a second inflatable base defining a second interior volume 108. The second interior volume 108 of the second inflatable base 107 receives air to inflate the second inflatable base 107 to a range of air pressures. Air may also be released from the second inflatable base 107 to create a range of air pressures. The second inflatable base 107 may be maintained at a desired pressure similarly to the first inflatable base 106. The pressure of the first and second inflatable bases 106, 107 may be different from each other.

A second valve 105 is connected with the second inflatable base 107. The second valve 105 is in fluid communication with the second interior volume 108 of the second inflatable base 107. The second valve 105 passes air into or out of the second interior volume 108 of the second inflatable base 107 to inflate the second inflatable base 107 to the range of air pressures. The second valve 105 is configured to operate similarly to the first valve 104 to inflate/deflate and control a pressure in the second inflatable base similarly to pressure regulation in the first inflatable base 106.

In some aspects, the base member 107 may be omitted and the inflatable base 101 may include only a single inflatable base (e.g., inflatable base 106) including a single interior volume 102. First and second valves (e.g., 104 or 204) may be connected with the interior volume 102 of the inflatable base 101. The first valve (e.g., 104 or 204) passes air into the interior volume 102 of the inflatable base 101, and the second valve (e.g., the other of 104 or 204) passes air out of the interior volume 102 of the inflatable base 101. When the base member 107 is employed, a first valve 105 and a second valve 205 may be connected with the interior volume 108 of the base member 107 and may operate similarly to the first and second valves 104 and 204, respectively.

The animal support apparatus 100 may include a headrest 109. The headrest 109 may extend from the inflatable base 101. The headrest 109 may include an interior volume 110. The interior volume 110 may be in fluid communication with the interior volume 102 of the inflatable base 101. The headrest 109 may also be a semi-rigid member that is not inflatable.

In some aspects, at least two handles (e.g., handles 131 and/or 132) are coupled to the inflatable base 101. The handles can be employed for lifting the inflatable base 101 (e.g., with the animal supported on the inflatable base 101).

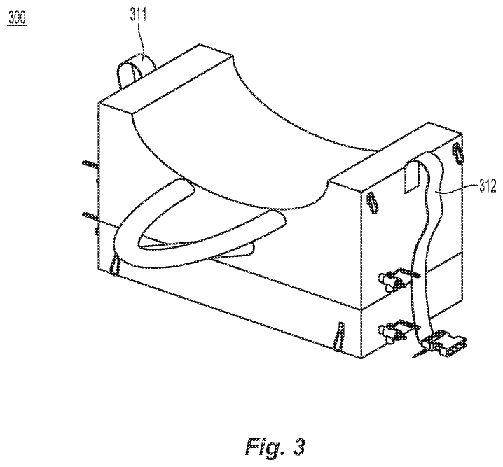

Unless otherwise indicated below, the animal support apparatuses 300 and 500 described with reference to FIGS. 3-4 and FIGS. 5-6 below are each substantially the same as the animal support apparatus 100 described above with reference to FIGS. 1-2 and 7, and thus duplicative descriptions may be omitted below.

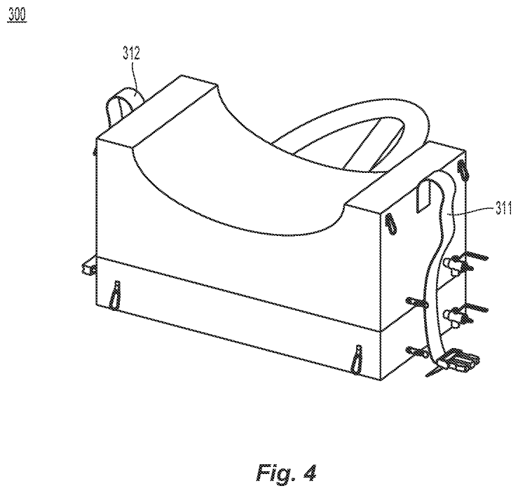

Referring to FIGS. 3-4, an animal support apparatus 300 may include a single strap mechanism 311, 312.

In use, the animal support apparatus 300 may be employed to support only a front portion (e.g., front paws) of an animal or a rear portion (e.g., rear paws) of an animal.

Referring to FIGS. 5-6, an animal support apparatus 500 may include a substantially cylindrical shape including a substantially flat upper surface 501.

In use, the animal support apparatus 500 may support an animal on the substantially flat upper surface 501.

From the foregoing and with reference to the various figure drawings, those skilled in the art will appreciate that certain modifications can also be made to the present disclosure without departing from the scope of the same. While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. An animal support apparatus, comprising:
an inflatable base defining an interior volume therein, the interior volume of the inflatable base configured to receive air to inflate the base to a range of air pressures, the inflatable base defining a recess, the recess configured to support an animal therein; and
at least one attachment strap coupled to the inflatable base, the at least one attachment strap configured to secure the animal in the recess of the inflatable base,
wherein the inflatable base is configured to connect with at least one valve to inflate the inflatable base to the range of air pressures.

2. The apparatus of claim 1, further including a plurality of eyelets coupled to the inflatable base, the plurality of eyelets configured to secure the animal in the recess of the inflatable base or to secure the inflatable base to a support table.

3. The apparatus of claim 1, wherein the inflatable base includes a base member and an animal support member, the animal support member disposed on the base member, and
wherein the base member is a second inflatable base defining a second interior volume therein, the second interior volume of the second inflatable base configured to receive air to inflate the second inflatable base to a range of air pressures.

4. The apparatus of claim 3, further including at least one second valve connected with the second inflatable base, the at least one second valve in fluid communication with the second interior volume of the second inflatable base, the at least one second valve configured to pass air into or out of the second interior volume of the second inflatable base to inflate the second inflatable base to the range of air pressures.

5. The apparatus of claim 3, wherein the base member is a flexible semi-rigid base member.

6. The apparatus of claim 1, further including at least one second valve connected with the interior volume of the inflatable base, wherein the at least one valve is configured to pass air into the interior volume of the inflatable base, and wherein the at least one second valve is configured to pass air out of the interior volume of the inflatable base.

7. The apparatus of claim 1, further including a headrest extending from the inflatable base.

8. The apparatus of claim 7, wherein the headrest is inflatable.

9. The apparatus of claim 8, wherein the headrest includes an interior volume in fluid communication with the interior volume of the inflatable base.

10. The apparatus of claim 1, further including at least two handles coupled to the inflatable base, the at least two handles configured for lifting the inflatable base with the animal supported thereon.

11. The apparatus of claim 1, further including a heating apparatus or a massage apparatus positioned about the inflatable base.

12. The apparatus of claim 1, further including at least one pocket or at least one pouch supported by the inflatable base.

13. The apparatus of claim 1, further including at least one valve connected with the inflatable base, the at least one valve in fluid communication with the interior volume of the inflatable base, the at least one valve configured to pass air into or out of the interior volume of the inflatable base to inflate the inflatable base to the range of air pressures

14. An animal support apparatus, comprising:
an inflatable base defining an interior volume therein, the interior volume of the inflatable base configured to receive air to inflate the base to a range of air pressures, the inflatable base configured to support an animal thereon;
at least one attachment strap coupled to the inflatable base, the at least one attachment strap configured to secure the animal to the inflatable base; and
at least one valve connected with the inflatable base, the at least one valve in fluid communication with the interior volume of the inflatable base, the at least one valve configured to pass air into or out of the interior volume of the inflatable base to inflate the inflatable base to the range of air pressures.

15. The apparatus of claim 14, further including a plurality of eyelets coupled to the inflatable base, the plurality of eyelets configured to secure the animal to the inflatable base or to secure the inflatable base to a support table.

16. The apparatus of claim 14, wherein the inflatable base includes a base member and an animal support member, the animal support member disposed on the base member, and
wherein the base member is a second inflatable base defining a second interior volume therein, the second interior volume of the second inflatable base configured to receive air to inflate the second inflatable base to a range of air pressures.

17. The apparatus of claim 16, further including at least one second valve connected with the second inflatable base, the at least one second valve in fluid communication with the second interior volume of the second inflatable base, the at least one second valve configured to pass air into or out of the second interior volume of the second inflatable base to inflate the second inflatable base to the range of air pressures.

18. The apparatus of claim 15, wherein the base member is a flexible semi-rigid base member.

19. The apparatus of claim 14, further including at least one second valve connected with the interior volume of the inflatable base, wherein the at least one valve is configured to pass air into the interior volume of the inflatable base, and wherein the at least one second valve is configured to pass air out of the interior volume of the inflatable base.

20. The apparatus of claim 14, further including a headrest extending from the inflatable base.

21. The apparatus of claim 20, wherein the headrest is inflatable.

22. The apparatus of claim 21, wherein the headrest includes an interior volume in fluid communication with the interior volume of the inflatable base.

23. The apparatus of claim 14, further including at least two handles coupled to the inflatable base, the at least two handles configured for lifting the inflatable base with the animal supported thereon.

24. The apparatus of claim 14, further including a heating apparatus or a massage apparatus positioned about the inflatable base.

25. The apparatus of claim 14, further including at least one pocket or at least one pouch supported by the inflatable base.
